(19) United States
(12) Patent Application Publication
(10) Pub. No.: US 2010/0259153 A1
(43) Pub. Date: Oct. 14, 2010

(54) LAMP USING LED LIGHT SOURCE

(76) Inventor: Takashi FUTAMI, Tokyo (JP)

Correspondence Address: KENEALY VAIDYA LLP, 515 EAST BRADDOCK RD SUITE B, Alexandria, VA, 22314, US

(21) Appl. No.: 12/759,205

(22) Filed: Apr. 13, 2010

(30) Foreign Application Priority Data
Apr. 13, 2009 (JP) 2009-097156

(51) Int. Cl. H01K 1/30

(52) U.S. Cl. 313/114

(57) ABSTRACT

A lamp can include an LED light source and a lens body having a first lens portion and a second lens portion arranged outside the first lens portion, the first and second lens portions being integrally formed with each other. The first lens portion can include a first light-incident surface and a refractive surface to form a main light distribution pattern condensation and refraction. The second lens portion can include a second light-incident surface, a first total-reflecting surface, a ring-shaped light projecting surface including an individual light projecting surface and a second total-reflecting surface, and a third total-reflecting surface. The second light-incident surface can be disposed beside the LED light source and can refract the light reaching the second light-incident surface to let the light enter the inside of the second lens portion. The first total-reflecting surface can totally reflect light entering through the second light-incident surface to condense the light in the front direction. The ring-shaped light projecting surface is disposed to cover an optical path range of light reflected from the first total-reflecting surface and is divided into a plurality of areas. The individual light projecting surface is provided in at least one of the plurality of divided areas and can transmit the light totally reflected from the first total-reflecting surface. The second total-reflecting surface can totally reflect the light from the first total-reflecting surface in the sideward and outward direction. The third total-reflecting surface can reflect light from the second total-reflecting surface to direct the light in the front direction.

This application claims the priority benefit under 35 U.S.C. §119 of Japanese Patent Application No. 2009-097156 filed on Apr. 13, 2009, which is hereby incorporated in its entirety by reference.

### TECHNICAL FIELD

The presently disclosed subject matter relates to a lamp using an LED light source, and in particular, relates to a lamp providing an attractive appearance with a virtual depth or a perceived three-dimensional appearance, and a visibility when seen by pedestrians and the like as well as having a thin profile.

### BACKGROUND ART

A conventional lamp using an LED light source is illustrated in FIG. 1 (for example, see Japanese Patent Application Laid-Open No. Sho 60-130001). The lamp 200 includes an LED light source 210 without directional characteristics, and a cap-type lens 220 that can effectively utilize the light from the LED light source 210 by primary refraction and secondary refraction. Another conventional lamp is illustrated in FIG. 2 (for example, see Japanese Patent Application Laid-Open No. 2001-76513). The lamp 300 includes an LED light source 310 with directional characteristics, and an optical member disposed in front of the LED light source 310 and having a plurality of reflectors. The light from the LED light source 310 can be reflected by the reflector 320 laterally. A plurality of reflectors 330 are arranged at different positions for receiving the reflected light and reflecting the same in the front direction. This configuration can provide a lamp with a plurality of light emission points with a single LED light source 310.

In the technical field of such lamps (in particular, a technical field of vehicle lamps utilizing an LED light source, such as a rear tail lamp or the like), there are strong demands to develop lamps with improved appearances as differential products.

### SUMMARY

In the lamp 200 as shown in FIG. 1, however, the light projecting portions 230 each have a circular shape, so that the projected light each is observed as a point source. Therefore, there is no significant difference in design between the lamp 200 and a lamp that has a single LED light source without such a lens. Furthermore, its outer appearance has no attractive feature, so that it would be difficult to differentiate the commercial product from others. In addition, as the lamp 200 of FIG. 1 can project light like that from a point source, the visibility when seen by pedestrians may be poor.

In contrast, the lamp 300 of FIG. 2 can achieve a novel appearance produced by the dispersed light projecting portions 340. In this configuration, however, the light projecting portions 340 must or should be disposed on a two-dimensional plane, and one can observe lighting points arranged just like a surface lighting system. Accordingly, the lamp can provide an appearance without a virtual depth and a three-dimensional sense, with less attractive design features. Furthermore, because of its specific structure, the center portion 350 where the LED light source 310 is disposed just below does not project light, and accordingly the area for projecting light may decrease by that area. This may disadvantageously diminish the visibility when seen by pedestrians.

The presently disclosed subject matter was devised in view of these and other problems and in association with the conventional art. According to an aspect of the presently disclosed subject matter, a lamp can provide an attractive appearance with a virtual depth or a three-dimensional sense, and a visibility when seen by pedestrians and the like as well as having a thin profile.

According to another aspect of the presently disclosed subject matter, a lamp can include: an LED light source having an optical axis in a front direction; and a lens body having a first lens portion and a second lens portion arranged outside the first lens portion, the first lens portion and the second lens portion being integrally formed with each other. The first lens portion can include a first light-incident surface and a refractive surface. The first light-incident surface can be disposed to cover an optical path range of light emitted from the LED light source in the front direction thereof and in a range of up to approximately 90 degrees with respect to the optical axis as a center. The first light-incident surface can be composed of a lens surface that can condense and refract the light reaching the first light-incident surface in the front direction to let the light enter the inside of the first lens portion. The refractive surface can be disposed to cover an optical path range of light entering through the first light-incident surface, and can be composed of a lens surface that can diffuse the light entering through the first light-incident surface to form a predetermined light distribution pattern. The second lens portion can include a second light-incident surface, a first total-reflecting surface, a ring-shaped light projecting surface including an individual light projecting surface and a second total-reflecting surface, and a third total-reflecting surface. The second light-incident surface can be disposed to cover an optical path range of light emitted from the LED light source in a sideward direction thereof and in a range of from approximately 90 degrees to 180 degrees with respect to the optical axis as a center. The second light-incident surface can be composed of a wall-like or cylindrical lens surface that can refract the light reaching the second light-incident surface to let the light enter the inside of the second lens portion. The first total-reflecting surface can be disposed to cover an optical path range of light entering through the second light-incident surface and can be composed of a reflecting surface that can totally reflect light entering through the second light-incident surface and reaching the first total-reflecting surface to condense the light in the front direction so that a predetermined light distribution pattern is formed. The ring-shaped light projecting surface can be disposed to cover an optical path range of light reflected from the first total-reflecting surface and be divided into a plurality of areas. The individual light projecting surface can be provided in at least one of the plurality of divided areas and can be composed of a lens surface that can transmit the light totally reflected from the first total-reflecting surface therethrough. The second total-reflecting surface can be provided in the remaining areas out of the plurality of divided areas where the individual light projecting surface is not provided, and can be composed of a reflecting surface that can totally reflect the light reflected by the first total-reflecting surface and reaching the second total-reflecting surface in the sideward and outward direction. The third total-reflecting surface can be disposed in an inclined state to cover an optical path range of light reflected from the second total-reflecting surface, and can be composed of a reflecting surface that can reflect light reflected from the second total-reflecting surface and reaching the third total-reflecting surface to direct the light in the front direction.

The lamp according to the above aspect of the presently disclosed subject matter can include an appropriate number of the individual light projecting surfaces and an appropriate number of the third total-reflecting surfaces disposed at respective appropriate positions. Accordingly, the lamp can achieve a novel appearance with a virtual depth or a three-dimensional sense rather than an appearance derived from a simple point source like the conventional lamp. Furthermore, the first lens portion can have the refractive surface disposed on the optical axis of the LED light source, so that the diffused light can be projected from the refractive surface. In this configuration, the central portion can be lit, and as a result, reduction of the light emission area can be prevented, thereby improving the visibility when seen by pedestrians. Namely, the configuration according to the present aspect of the disclosed subject matter can provide a lamp providing an attractive appearance with a virtual depth or a three-dimensional sense, and a visibility when seen by pedestrians and the like as well as having a thin profile.

According to another aspect of the presently disclosed subject matter, in the above configuration, the first light-incident surface can be a revolved hyperbolic surface or spherical surface having a rotary axis on the optical axis of the LED light source. The refractive surface can be a prismatic surface or a conical surface having a rotary axis on the optical axis of the LED light source. The second light-incident surface can be a wall-like or cylindrical lens surface having a rotary axis on the optical axis of the LED light source. The first total-reflecting surface can be a curved surface that can be formed by a cone or a revolved paraboloid in part.

According to the above aspect of the presently disclosed subject matter, the refractive surface can be a prismatic surface or a conical surface having a rotary axis on the optical axis of the LED light source. For example, the prismatic surface can be configured to diffuse the light on or adjacent the optical axis having the maximum luminance to the maximum degree while can converge the light, which enters farther from the optical axis, toward the center. This configuration can prevent the inferior appearance just like that derived from a point source. In addition, the second light-incident surface can be a wall-like or cylindrical lens surface having a rotary axis on the optical axis of the LED light source. This can further improve the light utilization efficiency.

In the above configuration, the first light-incident surface can be disposed within an angular range of ±45 degrees with respect to the optical axis, and the second light-incident surface can be disposed within angular ranges of from 45 degrees to 90 degrees and from −45 degrees to −90 degrees.

In the above configuration, the individual light projecting surface can occupy at least one-third of the plurality of divided areas of the ring-shaped light projecting surface.

At the center of the lens body of the above configuration, the first lens portion can form a bottom of a concave portion by the projecting refractive surface and the second lens portion can extend from the first lens portion so as to surround the projecting refractive surface toward the front direction.

In the above configuration, the plurality of individual light projecting surfaces can be disposed so as to be separated from each other, and the plurality of third total-reflecting surfaces can be disposed so as to be separated from each other.

According to the foregoing aspects of the presently disclosed subject matter, the lamp can provide an attractive appearance with a virtual depth or a perceived three-dimensional appearance, and a visibility when seen by pedestrians and the like as well as having a thin profile.

### BRIEF DESCRIPTION OF DRAWINGS

These and other characteristics, features, and advantages of the presently disclosed subject matter will become clear from the following description with reference to the accompanying drawings, wherein:

FIG. 1 is a cross-sectional view illustrating a conventional lamp;

FIG. 2 is a cross-sectional view illustrating another conventional lamp;

FIG. 3 is a cross-sectional view illustrating still another conventional lamp;

FIG. 4 is a perspective view illustrating an embodiment of a lamp made in accordance with principles of the presently disclosed subject matter;

FIG. 5 is a longitudinal cross-sectional view illustrating the lamp of FIG. 4, taken along the optical axis AX;

FIG. 6 is a transversal cross-sectional view illustrating the lamp of FIG. 4, taken along the optical axis AX;

FIG. 7 is a graph showing an exemplary light distribution pattern formed by the lamp of FIG. 4;

FIG. 8 is a perspective view illustrating an exemplary general lighting system utilizing the lamps of FIG. 4;

FIG. 9 is a perspective view illustrating a modified example of the lamp of FIG. 4 according to the presently disclosed subject matter; and

FIG. 10 is a graph showing an exemplary light distribution pattern formed by the modified example of the lamp of FIG. 9.

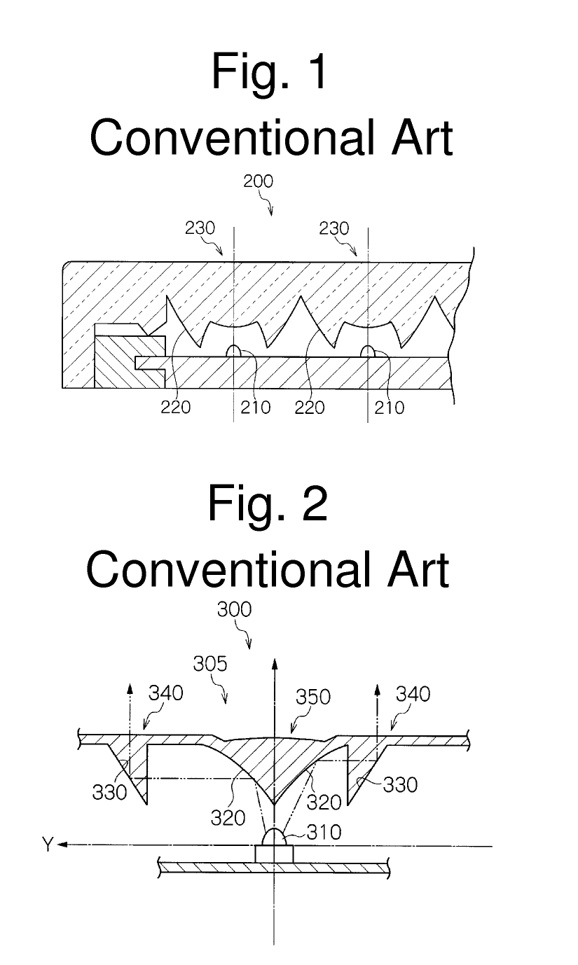

### DESCRIPTION OF EXEMPLARY EMBODIMENTS

A description will now be made below to a lamp of the presently disclosed subject matter with reference to the accompanying drawings in accordance with exemplary embodiments.

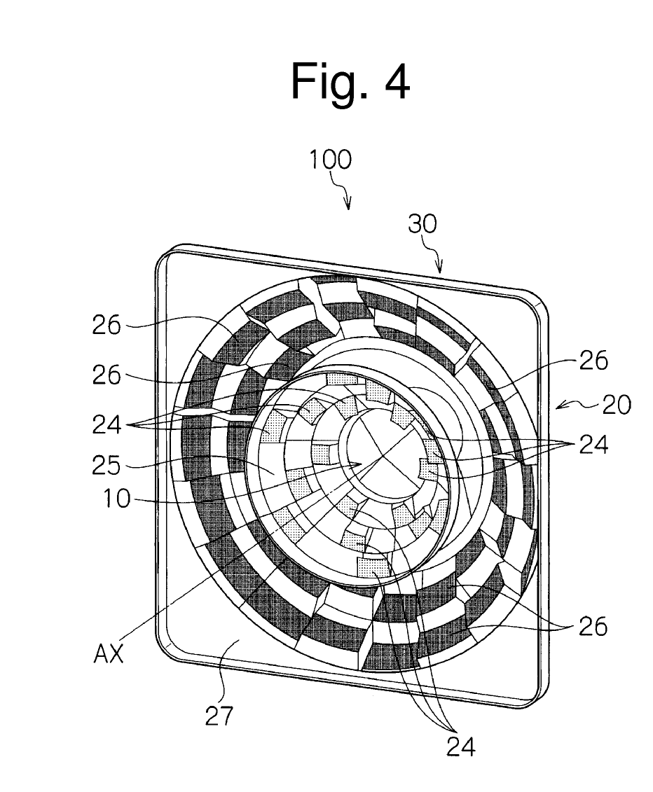

The lamp 100 of the present exemplary embodiment can be utilized in general lighting systems (such as, but not limited to, a downlight, a reading light, and an electric torch), vehicle signal lamps (such as, but not limited to, a tail lamp, a stop lamp, a turn signal lamp, a positioning lamp, and a daytime running lamp), and the like. As shown in FIGS. 4 to 6, the lamp 100 can include a lens body 30 and a chip-type LED light source 40 that has no specific directivity in terms of emission intensity. The lens body 30 can include a first lens portion 10 and a second lens portion 20 arranged outside the first lens portion 10, with the first lens portion 10 and the second lens portion 20 being integrally formed with each other using a transparent resin such as an acrylic resin or a polycarbonate resin. The lens body 30 can be designed to have, for example, a side of 36 mm and a depth of 14 mm, and a center light projection area of φ 33 mm. In this instance, the lens body 30 can be configured such that the first lens portion 10 can form a bottom of a concave portion by a projecting refractive surface to be described later. The second lens portion 20 can extend from the first lens portion 10 so as to surround the projecting refractive surface toward a front direction.

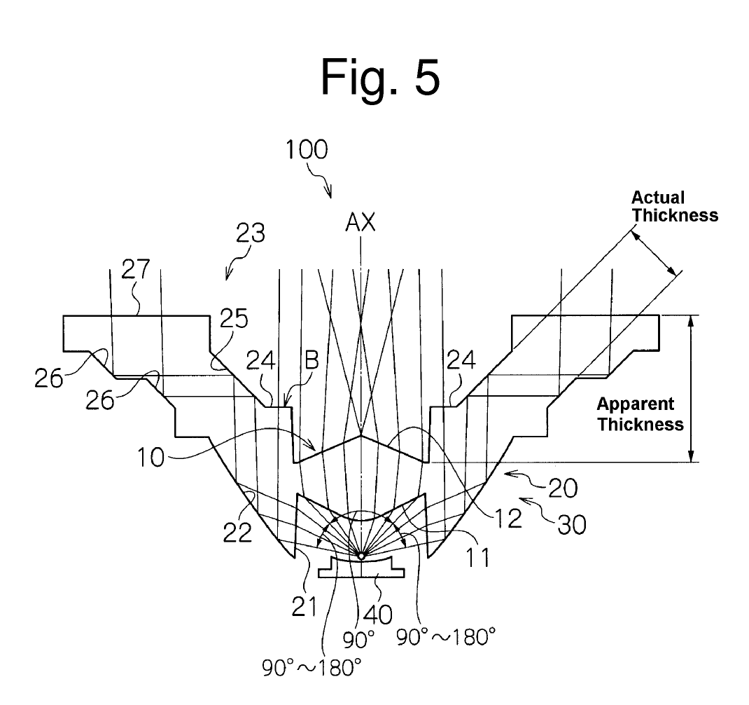

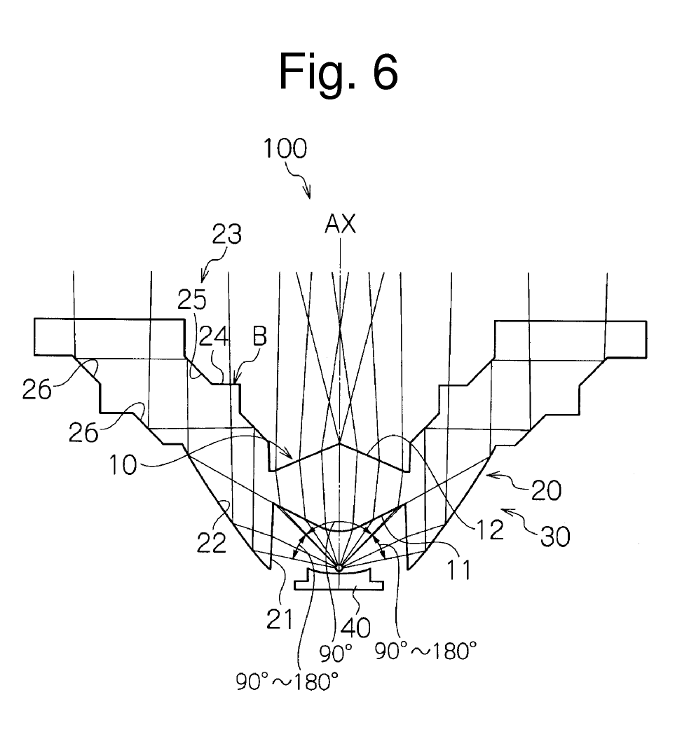

As shown in FIGS. 5 and 6, the first lens portion 10 can be disposed in front of the LED light source 40 in the light emission direction (or on the optical axis AX of the LED light source 40). The first lens portion 10 can include a first light-incident surface 11 disposed on the optical axis AX of the LED light source 40 in the front direction and a main light projecting surface 12 also serving as the refractive surface.

The first light-incident surface 11 can be disposed to cover an optical path range of light emitted from the LED light source 40 in the front direction thereof and in a range of up to approximately 90 degrees (or ±45 degrees as shown in FIGS. 5 and 6) with respect to the optical axis as a center. The first light-incident surface 11 can be composed of a lens surface that can condense and refract the light reaching the first light-incident surface 11 in the front direction to let the light enter the inside of the first lens portion 10. The first light-incident surface 11 can be a revolved hyperbolic surface or spherical surface having a rotary axis on the optical axis AX of the LED light source 40.

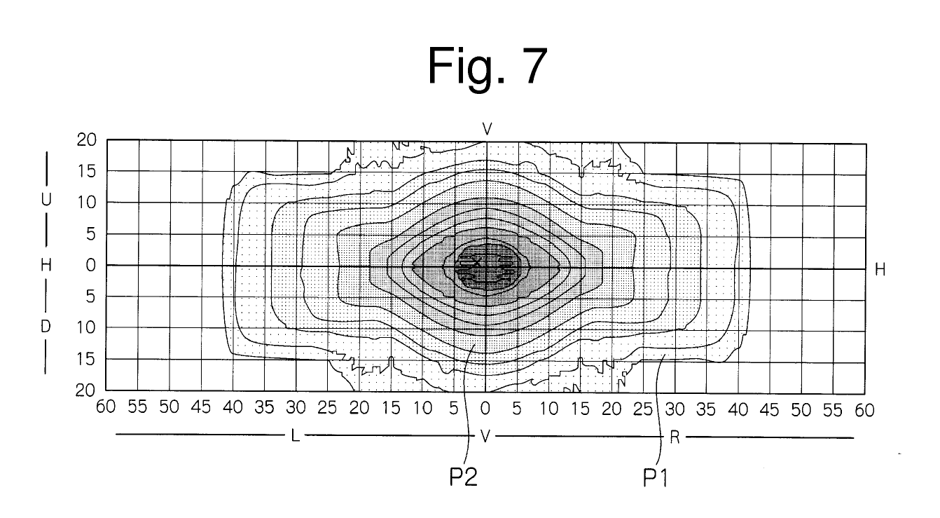

The main light projecting surface 12 can be disposed to cover an optical path range of light entering through the first light-incident surface 11, and can be composed of a lens surface that can diffuse the light entering through the first light-incident surface 11 and reaching the main light projecting surface 12 to form a main light distribution pattern P1 (see FIG. 7). The main light projecting surface 12 can be a prismatic surface or a conical surface having a rotary axis on the optical axis AX of the LED light source 40 (in the illustrated example of FIG. 4, being a rectangular pyramid prism shape).

As the first lens portion 10 can have the above configuration, the light that reaches the first lens portion 10 on or adjacent the optical axis AX and which has a maximum luminance can be diffused to the maximum degree while the light that enters farther from the optical axis AX and closer to the outer periphery of the first lens portion 10 can be condensed toward the center much more. Accordingly, this configuration can form a wider main light distribution pattern P1 (see FIG. 7) as well as the configuration can prevent an inferior appearance that may be derived from a point source by the LED light source 40.

The second lens portion 20 can include a second light-incident surface 21, a first total-reflecting surface 22, a ring-shaped light projecting surface 23 (including individual light projecting surfaces 24 and second total-reflecting surfaces 25 for separating the individual light projecting surfaces 24 from each other), and third total-reflecting surfaces 26.

The second light-incident surface 21 can be disposed to cover an optical path range of light emitted from the LED light source 40 in a sideward direction thereof and in a range of from approximately 90 degrees to 180 degrees (from 45 degrees to 90 degrees and from −45 degrees to −90 degrees) with respect to the optical axis as a center. The second light-incident surface 21 can be composed of a wall-like or cylindrical lens surface that can refract the light reaching the second light-incident surface 21 to let the light enter the inside of the second lens portion 20. The second light-incident surface can be, for example, a wall-like or cylindrical lens surface having a rotary axis on the optical axis AX of the LED light source 40.

The first total-reflecting surface 22 can be disposed to cover an optical path range of light entering through the second light-incident surface 21 and can be composed of a reflecting surface that can totally reflect light entering through the second light-incident surface 21 and reaching the first total-reflecting surface 22 to condense the light in the front direction so as to form a predetermined auxiliary light distribution pattern P2 (for illuminating the center area, as shown in FIG. 7). The first total-reflecting surface 22 can be a curved surface that can be formed by a cone or a revolved paraboloid formed by rotating a straight or curved line around the optical axis AX of the LED light source 40.

The ring-shaped light projecting surface 23 can be disposed to cover an optical path range of light reflected from the first total-reflecting surface 22. As shown in FIG. 4 and the like, the ring-shaped light projecting surface 23 can be divided into a plurality of areas arranged in a concentric and radial manner around the optical axis AX of the LED light source 40.

The individual light projecting surfaces 24 can occupy at least one area out of the divided areas of the light projecting surface 23 (in the shown exemplary embodiment, one-third of the plurality of divided areas). For example, the individual light projecting surfaces 24 can be arranged at the block B as shown in FIGS. 5 and 6. The individual light projecting surfaces 24 can transmit light totally reflected by the first total-reflecting surface 22. For example, the individual light projecting surface 24 can be composed of a planer lens surface (light emission surface) perpendicular to the optical axis AX of the LED light source 40. Depending on the intended applications, the individual light projecting surface 24 can be composed of a fisheye lens or a lens having a various lens cut, thereby diffusing the projecting light from the individual light projecting surface 24.

In the present exemplary embodiment, the plurality of individual light projecting surfaces 24 can be disposed so as not to be adjacent to each other in the one-third areas out of the divided areas (see FIG. 4). That is, the individual light projecting surfaces can be separated from each other and/or misaligned relative to one another.

The light emitted and diffused from the LED light source 40 in the sideward direction (in the angular range of from 90 degrees to 180 degrees (from ±45 degrees to ±90 degrees, respectively, as illustrated in FIGS. 5 and 6)) can reach the second light-incident surface 21. The light can be refracted by the second light-incident surface 21 and enter the inside of the second lens portion 20 to reach the first total-reflecting surface 22. The light can be condensed by the first total-reflecting surface 22 and reflected by the same toward the individual light projecting surfaces 24. The light reaching the individual light projecting surfaces 24 may be slightly diffused and can be projected therethrough to form a light distribution pattern P2. The light distribution pattern P2 can have an improved luminous intensity that can overlap with the main light distribution pattern P1 (see FIG. 7).

The second total-reflecting surface 25 can be provided in the remaining areas (two-thirds) out of the plurality of divided areas where the individual light projecting surface 24 is not provided, and can be provided in an inclined state where the surface 25 can form an angle of 45 degrees or so with respect to the optical axis AX. The second total-reflecting surface 25 can be composed of a reflecting surface that can totally reflect the light reflected by the first total-reflecting surface 22 and reaching the second total-reflecting surface 25 outward and sideward.

The third total-reflecting surface 26 can be disposed in an inclined state by a predetermined angle with respect to the optical axis AX so as to cover the optical path range of the light reflected from the second total-reflecting surface 25. The third total-reflecting surface 26 can be composed of a reflecting surface that can reflect light reflected from the second total-reflecting surface 25 and reaching the third total-reflecting surface 26 to direct the light in the front direction (toward the light projecting surface 27). Accordingly, the third total-reflecting surface 26 can serve as a light emission surface.

In the present exemplary embodiment, the plurality of the third total-reflecting surfaces 26 each can have a shape corresponding to any of the plurality of second total-reflecting surfaces 25 disposed at the respective divided areas. In a possible mode, the plurality of third total-reflecting surfaces 26 can be disposed so as not to be adjacent to each other. That is, the individual light projecting surfaces can be separated from each other and/or misaligned relative to one another.

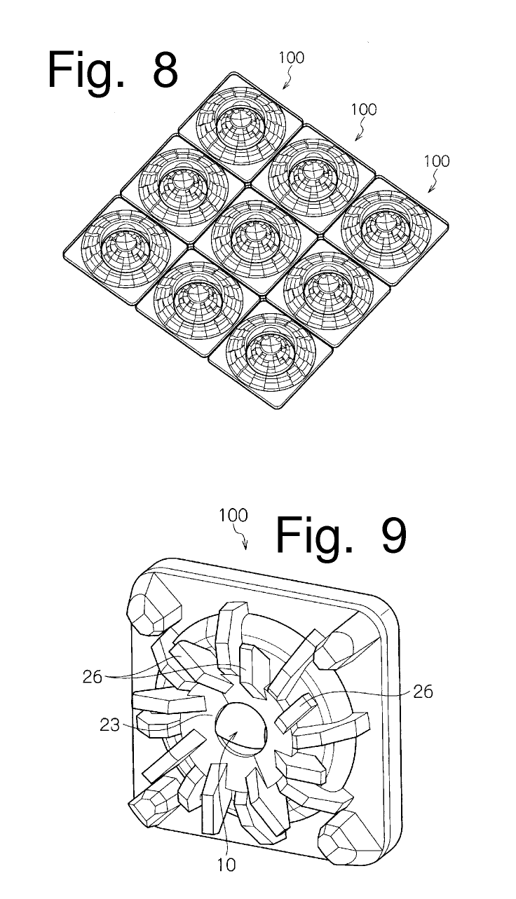

FIG. 8 illustrates an exemplary general lighting system utilizing nine (9) lamps 100 of the above configuration, so as to serve as, for example, a downlight. As shown, the second lens portion 20 can provide a polygonal outer appearance that can achieve a crystalline appearance which conventional lamps may not obtain.

The lamp 100 with the above configuration can include an appropriate number of the individual light projecting surfaces 24 and an appropriate number of the third total-reflecting surfaces 26 disposed at respective appropriate positions. Accordingly, the lamp 100 can achieve a novel appearance with a virtual depth or a three-dimensional sense rather than an appearance derived from a simple point source like the conventional lamp. Further, the first lens portion 10 and the second lens portion 20 (including the individual light projecting surfaces 24 and the third total-reflecting surfaces 26) can serve as light emission portions, thereby providing a novel lighting status where the emitted light can be continuously observed.

In the lamp 100 of the present exemplary embodiment, the first lens portion 10 can include the refractive surface (or main light projecting surface) 12 disposed on the optical axis AX of the LED light source 40. The light can be projected through the refractive surface 12 while diffused. Accordingly, the light can be observed at the center portion of the lens body 30. As a result, reduction of the light emission area can be prevented, thereby improving the visibility when seen by an observer.

Namely, the lamp 100 of the present exemplary embodiment can provide an attractive appearance with a virtual depth or a three-dimensional sense, and a visibility when seen by an observer as well as having a thin profile.

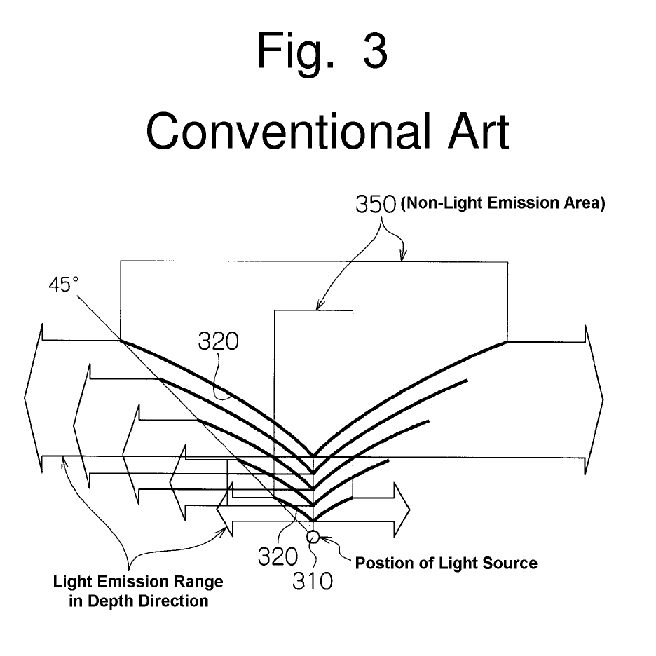

In general techniques, when a lens is imparted with an appearance with a certain depth or a three-dimensional sense, the thickness of the lens must or should be increased. For example, the lamp 300 as described in Japanese Patent Application Laid-Open No. 2001-76513 (see FIG. 2) can provide a three-dimensional appearance (depth) during light emission by increasing the thickness of the lens 305. However, when the thickness of the lens 305 increases, first, as shown in FIG. 3, the area of the center portion 350 where the light cannot be observed can be widened. Accordingly, the light emission area when viewed from the front side may be reduced by that area. Second, when the thickness of the lens 305 increases, the focusing distance of the reflecting surface 320 may be elongated, thereby disadvantageously expanding the depth from the light source 310 to the center portion 350 of the lens.

In contrast, the lamp 100 of the present exemplary embodiment can have a concave portion at the center of the lens body 30 (see FIGS. 4 to 6). Accordingly, when compared with the lamp 300 described in Japanese Patent Application Laid-Open No. 2001-76513, the lens thickness of the lamp 100 does not need to increase to provide a perceived thickness (a virtual depth or a perceived three-dimensional appearance, see FIG. 5).

Further, in the lamp 100 of the present exemplary embodiment the refractive surface 12 can be a prismatic surface or a conical surface having a rotary axis on the optical axis AX of the LED light source 40, so that the surface 12 can diffuse the light on or adjacent the optical axis AX of the LED light source 40 having the maximum luminance to the maximum degree while converging the light, which enters farther from the optical axis, toward the center. This configuration can prevent the inferior appearance just like a point source by the LED light source 40. In addition, as the second light-incident surface 21 can be a wall-like or cylindrical lens surface having a rotary axis on the optical axis AX of the LED light source 40, the light laterally emitted from the LED light source 40 can be guided toward the light projecting direction (front direction). Accordingly, the light utilization efficiency can be further improved.

Further, in the lamp 100 of the present exemplary embodiment the lens body 30 can include the refractive surface 12 (for example, prism cut), the second total-reflecting surface 25, the third total-reflecting surface 26, and the like. In this configuration, when the lamp is turned off, external light can be incident on the plurality of surfaces to be reflected by the same. Accordingly, even when the lamp is not lit, the lamp can be observed with a crystalline appearance.

It should be noted that the ratio of the individual light projecting surfaces 24 occupying the plurality of divided areas is not limited to one-third, but can be changed depending on the intended application and/or design.

Further, it should be noted that the light projecting surface 12 (or refractive surface) of the first lens portion 10 can be divided into a plurality of areas just like the second lens portion 20, so that concavo-convex blocks can be formed to alter the positions of the light projecting surfaces. This configuration can further improve the aesthetic appearance.

In terms of functionality, the single lens body 30 can achieve certain aspects of the presently disclosed subject matter. In another exemplary embodiment of the presently disclosed subject matter, the lens body 30 can be subjected to surface treatments such as a high brightening treatment (for example, aluminum deposition or sputtering), silver coating, or color coating, on the entire rear surface except for the first and second light-incident surfaces 11 and 22. Alternatively, a housing (not shown) may be provided to an area that should not hinder the light from the LED light source 40, with the housing being subjected to surface treatments such as a high brightening treatment (for example, aluminum deposition or sputtering), silver coating, or color coating, on the inner surface of the housing. This additional configuration can impart the jewelry-like appearance even when the lamp is not lit, thereby improving its value as a merchandisable product.

In a modified exemplary embodiment, a cover can be used to conceal the inside of the LED light source 40 or so through the lens body 30. The cover may be subjected to surface treatments such as a high brightening treatment (for example, aluminum deposition or sputtering), silver coating, or color coating, on the surface thereof. This cover can conceal the inside thereof when the lamp is not lit. When the lamp is lit, the circular light emission surface of the first lens portion 10 and the second lens portion 20 can be composed of the plurality of light emission surfaces including the second total-reflecting surfaces 25, the third total-reflecting surfaces 26, and the like, thereby achieving a three-dimensional light emission state.

It should be noted that the additional second and third total-reflecting surfaces 25 and 26 can merely direct the light within the lens body in a totally reflecting manner, and accordingly, the light loss thereby may be less than a general reflector (for example, an aluminum deposited reflector with a reflectivity of 85%) that loses approximately 15% of light per one reflection.

In the lamp 100 of the present exemplary embodiment, the lens body 30 can be formed integrally (as a unit). Accordingly, the reflecting surfaces of the lamp 100 can avoid the problem relating to positioning with a certain precision. Furthermore, there is no need to subject the parts to a surface treatment to form a reflector. It is thus possible to minimize costs.

It should be noted that the lamp efficiency of the circular light emission area of the first and second lens portions 10 and 20 without the additional second and third total-reflecting surfaces 25 and 26 is 70% while the lamp efficiency of the present exemplary embodiment is 62%. The difference of 8% is inevitable loss due to two-time total reflection and considered as a non-problematic level in actual usages. Rather than this, the presently disclosed subject matter is advantageous in the increased light emission area.

In the lamp 100 of the present exemplary embodiment, the single lens body 30 can provide a novel appearance where a plurality of light emission points are arranged in a certain three-dimensional space rather than as a conventional point source. Accordingly, the degree of design freedom for lamps can be enhanced.

The lamp 100 of the present exemplary embodiment can also achieve a novel appearance with the prismatic lens configuration while maintaining its high light utilization efficiency.

The lamp 100 of the present exemplary embodiment can also prevent the inferior appearance just like a point source by the LED light source 40, as the surface 12 can diffuse the light near the center, having the maximum luminance, to the maximum degree.

Further, the lamp 100 of the present exemplary embodiment can be composed of a combination of so called prismatic lenses. Accordingly, when the lamp is not lit, the external light can be incident on the total-reflecting surfaces 25 and 26, and the like disposed at 45 degrees, thereby providing a glittering appearance with crystalline-like sense. This configuration can improve its value as a merchandisable lamp product.

In the lamp 100 of the present exemplary embodiment, non-directional LED light sources of Lambertian emission can be employed to achieve a lamp having an appearance with a plurality of light emission points while the efficiency does not deteriorate.

In the lamp 100 of the present exemplary embodiment, the light can be directed to the respective light projecting surfaces by the total reflection within the lens body 30 without significantly suppressed light loss due to the reflection. Accordingly, even with the number of reflections, the light utilization efficiency can be improved.

Furthermore, in the lamp 100 of the present exemplary embodiment, the reflecting surfaces and/or lenses for reflecting/directing the light from the LED light source 40 sideward and outward and those for reflecting/directing the light in the front direction can be formed as an integral single lens member. Accordingly, the reflecting surfaces of the lamp 100 do not have the problem relating to positioning with a certain precision. Furthermore, there is no need to subject the parts to a surface treatment to form a reflector. It is thus possible to prevent the increasing costs while achieving a superior appearance.

Next, another modified embodiment will be described.

In the above exemplary embodiment, the individual light projecting surfaces 24 can occupy at least one area out of the divided areas of the ring-shaped light projecting surface (in the shown exemplary embodiment, one-third of the plurality of divided areas), such as the block B (see FIGS. 4 and 5). The presently disclosed subject matter however is not limited thereto. For example, the ring-shaped light projecting surface 23 may be a continuous light emission surface as shown in FIG. 9.

Furthermore, in the above exemplary embodiment, the plurality of light emission portions (such as the third total-reflecting surfaces 26) can be provided in corresponding areas divided and arranged in a concentric manner (see FIGS. 5 and 6). The presently disclosed subject matter is not limited thereto. For example, the plurality of light emission portions (such as the third total-reflecting surfaces 26) can be formed to radially extend with an appropriate dimension around the optical axis AX as a center.

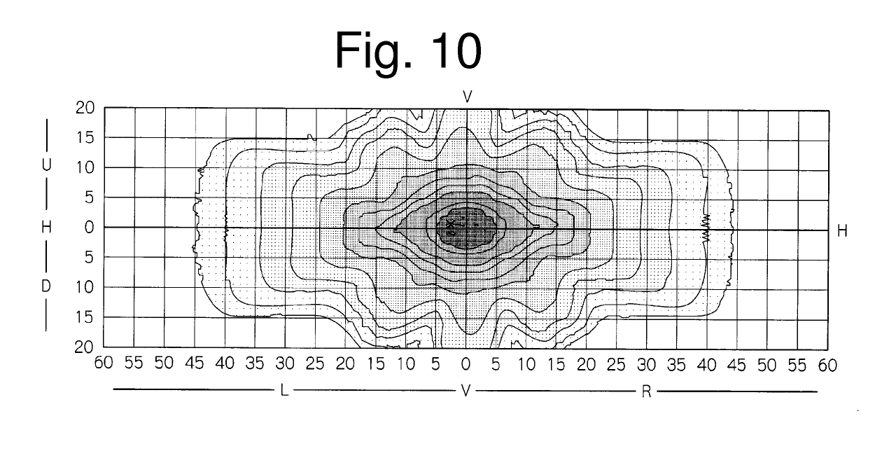

FIG. 10 illustrates the light distribution pattern that can be formed by the lamp of the present exemplary embodiment as shown in FIG. 9. Even in this case, almost the same characteristic light distribution pattern can be formed as that shown in FIG. 7.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A lamp, comprising:
an LED light source having an optical axis in a front direction; and
a lens body having a first lens portion and a second lens portion arranged outside the first lens portion, the first lens portion and the second lens portion being integrally formed with each other, wherein
the first lens portion includes a first light-incident surface and a refractive surface;
the first light-incident surface is disposed to cover an optical path range of light emitted from the LED light source in the front direction thereof and in a range of up to approximately 90 degrees with respect to the optical axis as a center, the first light-incident surface being composed of a lens surface configured to condense and refract the light emitted from the LED light source and reaching the first light-incident surface in the front direction to let the light enter an inside of the first lens portion;
the refractive surface is disposed to cover an optical path range of light entering through the first light-incident surface, and is composed of a lens surface configured to diffuse the light entering through the first light-incident surface to form a predetermined light distribution pattern;
the second lens portion includes a second light-incident surface, a first total-reflecting surface, a ring-shaped light projecting surface including an individual light projecting surface and a second total-reflecting surface, and a third total-reflecting surface;
the second light-incident surface is disposed to cover an optical path range of light emitted from the LED light source in a sideward direction thereof and in a range of from approximately 90 degrees to 180 degrees with respect to the optical axis as a center, the second light-incident surface being composed of a wall-like or cylindrical lens surface configured to refract the light reaching the second light-incident surface to let the light enter an inside of the second lens portion;
the first total-reflecting surface is disposed to cover an optical path range of light entering through the second light-incident surface and is composed of a reflecting surface configured to totally reflect light entering through the second light-incident surface and reaching the first total-reflecting surface to condense the light in the front direction so that a predetermined light distribution pattern is formed;
the ring-shaped light projecting surface is disposed to cover an optical path range of light reflected from the first total-reflecting surface and be divided into a plurality of divided areas;
the individual light projecting surface is provided in at least one of the plurality of divided areas and is composed of a lens surface configured to transmit light totally reflected from the first total-reflecting surface therethrough;
the second total-reflecting surface is provided in remaining areas of the plurality of divided areas where the individual light projecting surface is not provided, and is composed of a reflecting surface configured to totally reflect light reflected by the first total-reflecting surface and reaching the second total-reflecting surface in the sideward and outward direction; and
the third total-reflecting surface is disposed in an inclined state to cover an optical path range of light reflected from the second total-reflecting surface, and is composed of a reflecting surface configured to reflect light reflected from the second total-reflecting surface and reaching the third total-reflecting surface to direct the light in the front direction.

2. The lamp according to claim 1, wherein:
the first light-incident surface is any one of a revolved hyperbolic surface and a spherical surface having a rotary axis on the optical axis of the LED light source;
the refractive surface is any one of a prismatic surface and a conical surface having a rotary axis on the optical axis of the LED light source;
the second light-incident surface is any one of a wall-like lens surface and a cylindrical lens surface having a rotary axis on the optical axis of the LED light source; and
the first total-reflecting surface is a curved surface that is formed by any one of a cone and a revolved paraboloid in part.

3. The lamp according to claim 1, wherein:
the first light-incident surface is disposed within an angular range of ±45 degrees with respect to the optical axis; and
the second light-incident surface is disposed within angular ranges of from 45 degrees to 90 degrees and from −45 degrees to −90 degrees.

4. The lamp according to claim 2, wherein:
the first light-incident surface is disposed within an angular range of ±45 degrees with respect to the optical axis; and
the second light-incident surface is disposed within angular ranges of from 45 degrees to 90 degrees and from −45 degrees to −90 degrees.

5. The lamp according to claim 1, wherein the individual light projecting surface occupies at least one-third of the plurality of divided areas of the ring-shaped light projecting surface.

6. The lamp according to claim 2, wherein the individual light projecting surface occupies at least one-third of the plurality of divided areas of the ring-shaped light projecting surface.

7. The lamp according to claim 3, wherein the individual light projecting surface occupies at least one-third of the plurality of divided areas of the ring-shaped light projecting surface.

8. The lamp according to claim 4, wherein the individual light projecting surface occupies at least one-third of the plurality of divided areas of the ring-shaped light projecting surface.

9. The lamp according to claim 1, wherein:
at a center of the lens body, the first lens portion forms a bottom of a concave portion by the refractive surface; and
the second lens portion extends from the first lens portion so as to surround the refractive surface toward the front direction.

10. The lamp according to claim 2, wherein:
at a center of the lens body, the first lens portion forms a bottom of a concave portion by the refractive surface; and
the second lens portion extends from the first lens portion so as to surround the refractive surface toward the front direction.

11. The lamp according to claim 3, wherein:
at a center of the lens body, the first lens portion forms a bottom of a concave portion by the refractive surface; and
the second lens portion extends from the first lens portion so as to surround the refractive surface toward the front direction.

12. The lamp according to claim 4, wherein:
at a center of the lens body, the first lens portion forms a bottom of a concave portion by the refractive surface; and
the second lens portion extends from the first lens portion so as to surround the refractive surface toward the front direction.

13. The lamp according to claim 5, wherein:
at a center of the lens body, the first lens portion forms a bottom of a concave portion by the refractive surface; and
the second lens portion extends from the first lens portion so as to surround the refractive surface toward the front direction.

14. The lamp according to claim 6, wherein:
at a center of the lens body, the first lens portion forms a bottom of a concave portion by the refractive surface; and
the second lens portion extends from the first lens portion so as to surround the refractive surface toward the front direction.

15. The lamp according to claim 7, wherein:
at a center of the lens body, the first lens portion forms a bottom of a concave portion by the refractive surface; and
the second lens portion extends from the first lens portion so as to surround the refractive surface toward the front direction.

16. The lamp according to claim 8, wherein:
at a center of the lens body, the first lens portion forms a bottom of a concave portion by the refractive surface; and
the second lens portion extends from the first lens portion so as to surround the refractive surface toward the front direction.

17. The lamp according to claim 1, wherein:
the plurality of individual light projecting surfaces are disposed so as to be separated from each other; and
the plurality of third total-reflecting surfaces are disposed so as to be separated from each other.

18. The lamp according to claim 2, wherein:
the plurality of individual light projecting surfaces are disposed so as to be separated from each other; and
the plurality of third total-reflecting surfaces are disposed so as to be separated from each other.

19. The lamp according to claim 3, wherein:
the plurality of individual light projecting surfaces are disposed so as to be separated from each other; and
the plurality of third total-reflecting surfaces are disposed so as to be separated from each other.

20. The lamp according to claim 5, wherein:
the plurality of individual light projecting surfaces are disposed so as to be separated from each other; and
the plurality of third total-reflecting surfaces are disposed so as to be separated from each other.

21. The lamp according to claim 9, wherein:
the plurality of individual light projecting surfaces are disposed so as to be separated from each other; and
the plurality of third total-reflecting surfaces are disposed so as to be separated from each other.
